(19) United States
(12) Patent Application Publication
(10) Pub. No.: US 2024/0411825 A1
(43) Pub. Date: Dec. 12, 2024

(54) SYSTEM FOR PROVIDING USER-CUSTOMIZED INFORMATION BY USING AUTONOMOUS DRIVING DEVICE

(71) Applicant: INTEGRIT INC., Seoul (KR)

(72) Inventor: Han Hee CHO, Seoul (KR)

(73) Assignee: INTEGRIT INC., Seoul (KR)

(21) Appl. No.: 18/702,336

(22) PCT Filed: Sep. 26, 2022
(86) PCT No.: PCT/KR2022/014336

§ 371 Date: Apr. 18, 2024

(30) Foreign Application Priority Data
Oct. 22, 2021 (KR) 10-2021-0141677

(51) Int. Cl. G06F 16/9535; G01J 5/00; G01J 5/48; G06K 19/06

(52) U.S. Cl. CPC G06F 16/9535; G01J 5/48; G06K 19/06037; G01J 2005/0077

(57) ABSTRACT

A system for providing user-customized information by using an autonomous driving device, includes: an autonomous driving device unit which recognizes at least one user, analyzes specific information of the recognized user, recognizes and analyzes environmental information of the corresponding user, defines contextual information necessary for the corresponding user on the basis of the specific information and the environmental information, and receives customized content information according to the contextual information fed back through Internet and intra network searching, and provides same; and a server unit which is connected to the autonomous driving device unit through the Internet and the intra network, and extracts the customized content information according to the search request from the autonomous driving device unit and feeds back same to the autonomous driving device unit.

### TECHNICAL FIELD

The present invention relates to a system for providing user-customized information using an autonomous driving device.

### BACKGROUND ART

Recent advances in intelligent robotics technology have made it possible to provide various types of content, services, and the like to users through robots connected to the Internet. These intelligent robots provide various types of content and service, such as news, weather, educational content, schedule reminders, wake-up calls, home monitoring, cleaning, and the like, through, for example, communication with users, emotional responses to user commands, reactions with actions in certain situations, and the like. Meanwhile, network-based intelligent robots provide interactive two-way content and services to users. However, the network-based intelligent robots operate to receive user commands or specific requirement values and extract and provide information accordingly, and thus require a rather cumbersome input process and corresponding time to obtain information that users need.

### DISCLOSURE

### Technical Problem

The present invention is directed to providing a system for providing user-customized information using an autonomous driving device which automatically recognizes and analyzes a user and his or her surroundings using an autonomous driving device and provides contextualized user-customized information.

### Technical Solution

One aspect of the present invention provides a system for providing user-customized information using an autonomous driving device, the system including an autonomous driving device unit configured to recognize at least one user, analyze specific information of the recognized user, recognize and analyze surrounding information of the user, define situation information necessary for the user on the basis of the specific information and the surrounding information, receive customized content information according to the situation information fed back through Internet and intranet searching, and provide the customized content information, and a server unit connected to the autonomous driving device unit through an Internet and an intranet and configured to extract the customized content information according to a search request from the autonomous driving device unit and feed back the customized content information to the autonomous driving device unit.

The autonomous driving device unit may include a travel body unit including at least one of an autonomous driving robot and an autonomous driving drone, an image capturing unit configured to capture an image of the user, a thermographic sensor unit configured to measure a body temperature of the user using a thermal image, a user-specific information analysis unit configured to recognize the user on the basis of image data acquired through the image capturing unit and thermographic data acquired through the thermographic sensor unit and analyze the specific information including the recognized user's sex, age group, language group, and abnormality or normality in the body temperature, a surrounding sensor unit configured to generate the surrounding information by measuring a temperature, a humidity, and an air pollution level of surroundings of the user, a content feedback request unit configured to extract the situation information which is predefined in connection with the specific information and the surrounding information, request the customized content information from the server unit on the basis of the extracted situation information, and receive the customized content information, and a display unit configured to graphically process the customized content information fed back from the server unit through the content feedback request unit and display the graphically-processed customized content information.

The display unit may provide the customized content information through a touchscreen which supports a user interface, receive a search request for additional information for the customized content information through the user interface, transmit the search request for the additional information to the server unit, receive feedback information resulting from the search request for the additional information from the server unit, and display the feedback information.

The display unit may generate and display graphic code for the customized content information and the additional information, and when the graphic code is scanned through a user communication terminal, the server unit may be connected to the user communication terminal and provide the customized content information and the additional information to the user communication terminal.

The server unit may include a search means setting unit configured to receive a search request for the situation information from the autonomous driving device unit and set at least one of the Internet and the intranet as a means of searching for the situation information, an Internet content information providing unit configured to search the Internet for content related to the situation information, collect the content, and provide the collected data as the customized content information when the Internet is set as the search means by the search means setting unit, and an intranet content information providing unit configured to extract data which is prestored in connection with the situation information from the intranet and provide the data as the customized content information when the intranet is set as the search means by the search means setting unit.

The autonomous driving device unit may further include a user face recognition unit configured to recognize the user's face in the image data acquired through the image capturing unit and transmit recognition data of the recognized face to the server unit, the server unit may further include a user information enquiry unit configured to search for the user's disease history information, wanted notice information, and criminal history information on the basis of the face recognition data in conjunction with each of a police agency server and a medical institute server and when at least one of disease history information, wanted notice information, and criminal history information is received as a search result, store the received information and then transmits a user monitoring command to the autonomous driving device unit, and the autonomous driving device unit may further include a user monitoring unit configured to image the user and transmit captured image data to the server unit when the user monitoring command is received.

### Advantageous Effects

According to the present invention, it is possible to provide a system for providing user-customized information using an autonomous driving device which automatically recognizes and analyzes a user and his or her surroundings using an autonomous driving device and provides contextualized user-customized information.

### DESCRIPTION OF DRAWINGS

FIG. 1 is a schematic diagram illustrating the overall configuration and relationships between components of a system for providing user-customized information using an autonomous driving device according to an embodiment of the present invention.

FIG. 2 is a block diagram illustrating a configuration of an autonomous driving device unit according to the embodiment of the present invention.

FIG. 3 is a block diagram illustrating a configuration of a server unit according to the embodiment of the present invention.

FIG. 4 is a diagram illustrating a method of providing information to a user communication terminal using code graphic according to the embodiment of the present invention.

FIG. 5 is a diagram illustrating a user monitoring operation employing an autonomous driving device according to the embodiment of the present invention.

### BEST MODE OF THE INVENTION

Terminology used in the present specification will be briefly described first, and then the present invention will be described in detail.

As terms used herein, general terms currently used as widely as possible will be selected in consideration of functionality in the present invention, but may vary depending on the intent of those of ordinary skill in the art, precedents, the advent of new technology, and the like. In particular, a term may be arbitrarily selected by the applicant. In this case, the meaning of the term will be explained in detail through the relevant description of the invention. Therefore, the terms used herein should be defined on the basis of their meanings and the overall content of the present invention rather than their names.

Throughout the specification, when a part is referred to as “including” a component, other components are not excluded, and the part may further include other components unless specifically stated otherwise. Also, the terms “unit,” “module,” and the like used herein mean a unit that processes at least one function or operation, and may be implemented as hardware or software or a combination of hardware and software.

Hereinafter, embodiments of the present invention will be described in detail with reference to the accompanying drawings so that those skilled in the technical field to which the present invention pertains can easily implement the present invention. However, the present invention can be implemented in many different forms and is not limited to the embodiments described herein. To clearly describe the present invention, parts irrelevant to the description will be omitted in the drawings, and throughout the specification, like reference numerals refer to like parts.

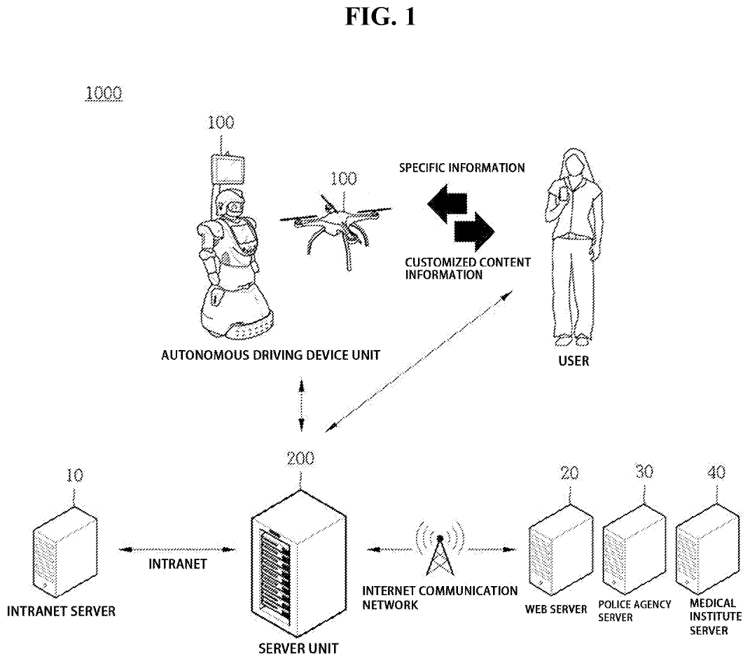

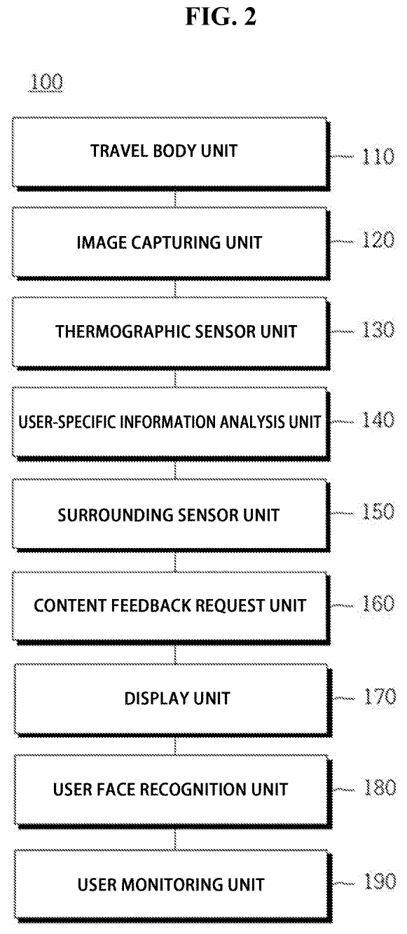

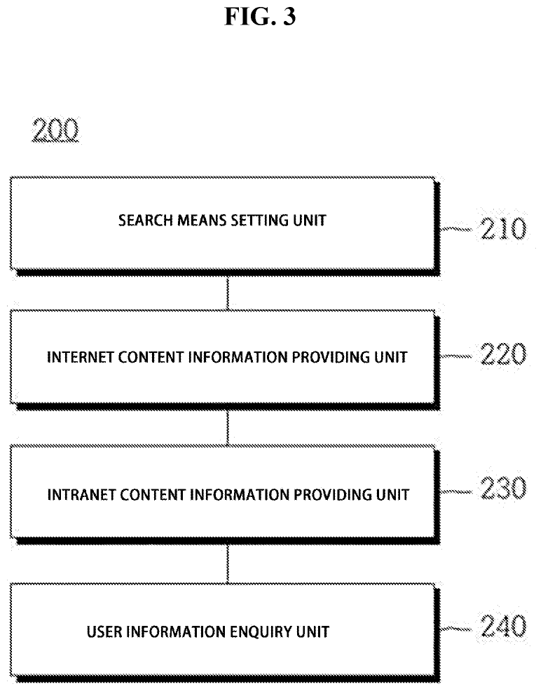

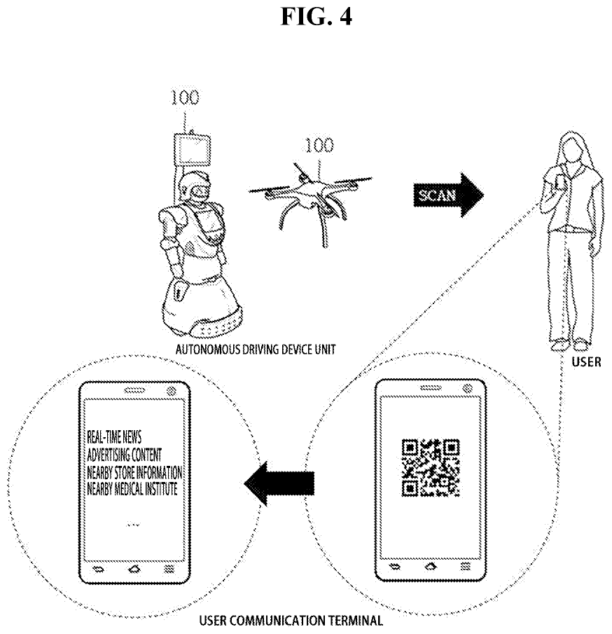

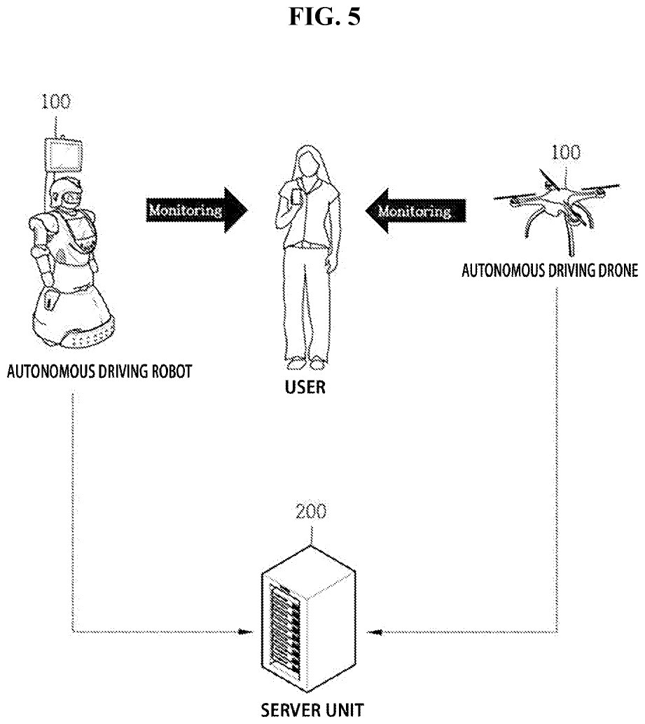

FIG. 1 is a schematic diagram illustrating the overall configuration and relationships between components of a system for providing user-customized information using an autonomous driving device according to an embodiment of the present invention, FIG. 2 is a block diagram illustrating a configuration of an autonomous driving device unit according to the embodiment of the present invention, FIG. 3 is a block diagram illustrating a configuration of a server unit according to the embodiment of the present invention, FIG. 4 is a diagram illustrating a method of providing information to a user communication terminal using code graphic according to the embodiment of the present invention, and FIG. 5 is a diagram illustrating a user monitoring operation employing an autonomous driving device according to the embodiment of the present invention.

Referring to FIG. 1, a system 1000 for providing user-customized information using an autonomous driving device according to the embodiment of the present invention includes an autonomous driving device unit 100 and a server unit 200.

The autonomous driving device unit 100 may recognize at least one user, analyze specific information of the recognized user, recognize and analyze surrounding information of the user, define situation information necessary for the user on the basis of the recognized specific information and surrounding information, receive customized content information according to the situation information fed back from the server unit 200 through Internet and intranet searching, and provide the customized content information to the user.

To this end, the autonomous driving device unit 100 may include at least one of a travel body unit 110, an image capturing unit 120, a thermographic sensor unit 130, a user-specific information analysis unit 140, a surrounding sensor unit 150, a content feedback request unit 160, a display unit 170, a user face recognition unit 180, and a user monitoring unit 190.

The travel body unit 110 may include at least one of an autonomous driving robot and an autonomous driving drone. To freely move in a certain space, the autonomous driving robot should be able to accurately recognize its current location and move from the recognized current location to a target location without any error. To this end, a certain landmark is used as a means of providing location information for allowing the autonomous driving robot to recognize its current location. The robot may recognize the landmark installed in a certain workspace through an image signal processing process of an external image captured by a camera and obtain location information for identifying its current location using the recognized landmark. In this way, the robot may be assigned to a set workspace and capture various images. The autonomous driving drone is a small airplane that operates without a human on board and may recognize and avoid obstacles on its own, move, and perform a specific task without receiving a control signal from a remote operator.

The image capturing unit 120 may recognize specific objects, that is, users (people), capture an image of each user to generate image data, transmit the generated image data to the user-specific information analysis unit 140 and the user face recognition unit 180, and store the image data in a memory such as a blackbox.

The thermographic sensor unit 130 may measure a body temperature of the user using a thermal image, and a thermographic camera may be employed for this purpose. The thermographic sensor unit 130 may track and detect heat, transmit the result of tracking and detection, that is, thermographic data, to the user-specific information analysis unit 140, and store the thermographic data in a memory such as a blackbox.

The user-specific information analysis unit 140 may recognize the users on the basis of the image data acquired through the image capturing unit 120 and the thermographic data acquired through the thermographic sensor unit 130 and analyze specific information of each recognized user.

For example, the user-specific information analysis unit 140 may analyze the image data through an artificial intelligence algorithm to determine each user's sex, age group, language group, and the like. In other words, on the basis of previously learned data, it is possible to determine whether a user included in image data is male or female, whether the user is in his or her teens, twenties, thirties, or the like, whether the user is an English speaker, a Chinese speaker, a Japanese speaker, a Korean speaker, or the like. Also, on the basis of the thermographic data, it is possible to determine whether the corresponding user's body temperature has increased (or decreased) rapidly, that is, whether the corresponding user's body temperature is abnormal.

The surrounding sensor unit 150 may generate surrounding information by measuring a temperature, a humidity, and an air pollution level of surroundings of the user and transmit the surrounding information to the content feedback request unit 160. To this end, the surrounding sensor unit 150 may include a temperature sensor, a humidity sensor, an air quality sensor, and the like.

The content feedback request unit 160 may extract situation information which is predefined in connection with specific information and surrounding information, request customized content information from the server unit 200 on the basis of the extracted situation information, and receive the customized content information accordingly.

For example, an autonomous driving robot passes around a specific user in an airport and acquires image data, thermographic data, and surrounding information of the user. When specific information that the user is an English-speaking male in his forties and has a body temperature of 37.2° C. to 37.5° C. and surrounding information that an ambient temperature and humidity are rising rapidly are identified, the autonomous driving robot extracts situation information predefined regarding what information is required by the user according to the specific information and the surrounding information and transmits the extracted situation information to the server unit 200, causing the server unit 200 to expose information which is determined to be required by the user, such as location information, menu information, advertising information, and the like of an ice cream store, a beverage store, and the like near the user, to the user. Also, when the body temperature is measured to be higher than 37.2° C. to 37.5° C., for example, 38° C. to 39° C., information which is currently required by the user may be identified by providing location information of a pharmacy, a medical office, and the like, information for calling a guide or the like, and other information, and optimal information for the user may be provided. Since the user is determined to be an English speaker as described above, various provided information may be translated into English, or content information created in English may be provided.

The display unit 170 may graphically or/and schematically process customized content information fed back from the server unit 200 through the content feedback request unit 160 and display the graphically or/and schematically processed customized content information on a screen.

Also, the display unit 170 may provide the customized content information through a touchscreen which supports a user interface, receive a search request for additional information for the customized content information through the user interface, transmit the search request for the additional information to the server unit 200, receive feedback information resulting from the search request for the additional information from the server unit 200, and display the feedback information.

For example, when customized content information, such as location information, menu information, advertising information, and the like of an ice cream store, a beverage store, and the like, or customized content information, such as location information of a pharmacy, a medical office, and the like, information for calling a guide or the like, is displayed through the display unit 170 and provided as described above, the user may check the information through the touchscreen and then request additional information, such as a menu button for checking detailed information and the like displayed on the touchscreen, a button for calling a guide, a menu for searching for information for using another service, searching for other information based on an Internet portal site, and the like or request a photograph captured by the autonomous driving device unit 100 through personal email, a search for a path for moving to another location in the corresponding place, or the like, and the autonomous driving device unit 100 may provide information additionally wanted by the user or newly provide information in conjunction with the service unit 200.

The display unit 170 may generate and display graphic code for customized content information and additional information. Such graphic code is generally provided as a quick response (QR) code. When the user has no time to check the corresponding information through the display unit 170 at the current location, link information for providing the customized content information and the additional information is generated as a QR code and provided so that the user can scan the QR code later using his or her communication terminal and personally check desired information.

The user face recognition unit 180 may recognize the user's face in the image data acquired by the image capturing unit 120 and transmit recognition data of the recognized face to the server unit 200. User face recognition is performed by extracting feature points shown in the face in the image, and face recognition data is generated on the basis of the feature values and transmitted to the server unit 200. In order for the server unit 200 to check information on the user using the face recognition data of the user, face recognition data of the user should be registered in advance, which will be described in detail below.

When a user monitoring command is received, the user monitoring unit 190 may image the corresponding user and transmit the image data to the server unit 200. Here, the user monitoring command is received from the server unit 200 when it is determined that it is necessary to monitor the user. When this user monitoring command is received, the autonomous driving device unit 100 may track the user at a certain distance from the user, acquire images of his or her action, and transmit the images to the server unit 200 in real time or periodically.

The server unit 200 may be connected to the autonomous driving device unit 100 through the Internet and the intranet and may extract customized content information according to a search request from the autonomous driving device unit 100 and feed back the customized content information to the autonomous driving device unit 100.

To this end, the server unit 200 may include a search means setting unit 210, an Internet content information providing unit 220, an intranet content information providing unit 230, and a user information enquiry unit 240.

The search means setting unit 210 may receive a search request for situation information of a user from the autonomous driving device unit 100 and set at least one of the Internet and the intranet as a means of searching for situation information. To this end, the search means setting unit 210 may be connected to each of an intranet server 10 and a web server 20.

For example, when the situation information includes specific information that a user who is a male in his forties has a body temperature of 37.2° C. to 37.5° C. and surrounding information that an ambient temperature and humidity are rising rapidly, the user may be determined not as a patient but as a user who needs a service in the corresponding airport, determined to use a facility service in the place, and determined to access the intranet (an airport server) and search for necessary information.

When the Internet is set as the search means by the search means setting unit 210, the Internet content information providing unit 220 may search the Internet for content related to the situation information of the user, collect the content, and provide the collected data as customized content information.

When the intranet is set as the search means by the search means setting unit 210, the intranet content information providing unit 230 may extract data which is prestored in connection with the situation information of the user from the intranet and provide the data as customized content information.

As a continuation of the above example, location information, menu information, advertising information, and the like of an ice cream store, a beverage store, and the like near the user may be determined as information required by the user, and airport service information required by the user may be searched for in the intranet and provided. Also, when the body temperature is measured to be 38° C. to 39° C., location information of a pharmacy, a medical office, and the like, information for calling a guide or the like, and other information may be provided through intranet searching.

The user information enquiry unit 240 may search for the user's disease history information, wanted notice information, and criminal history information on the basis of the face recognition data generated by the user face recognition unit 180 in conjunction with each of a police agency server 30 and a medical institute server 40 and when at least one of disease history information, wanted notice information, and criminal history information is received as a search result, store the received information and then transmits a user monitoring command to the autonomous driving device unit 100.

For example, when the user is determined to be a patient with a specific disease (e.g., epilepsy, a heart disease, or the like), the patient may be imaged at a certain distance at certain time intervals to monitor the patient's state or condition. Also, when the user is wanted or has a history of a specific crime, the autonomous driving device unit 100 may generate image data for observing the user's action by imaging the user at a specific distance at certain time intervals or in real time and transmit the image data to the server unit 200 to use the image data as evidence in the future.

Meanwhile, when graphic code (e.g., a QR code) is scanned through a user communication terminal, the server unit 200 may be connected to the user communication terminal and provide customized content information and additional information to the user communication terminal. In other words, when the user has no time to check the corresponding information through the display unit 170 at the current location, information to be provided through the display unit 170 may be provided to the user communication terminal using the QR code for providing the customized content information and the additional information.

The server unit 200 may include a program module that is implemented as software in various languages, such as C, C++, Java, Visual Basic, Visual C, and the like, to perform several functions. Also, the server unit 200 may be implemented in hardware for a general server using web server programs variously provided according to operating systems (OSs) such as DOS, Windows, Linux, Unix, Macintosh, and the like.

In addition, the server unit 200 is connected to each of the intranet server 10, the web server 20, the police agency server 30, and the medical institute server 40 through a network. Examples of the network include, but are not limited to, a radio frequency (RF) network, a Third Generation Partnership Project (3GPP) network, a Long Term Evolution (LTE) network, a Fifth Generation Partnership Project (5GPP) network, a World Interoperability for Microwave Access (WiMAX) network, the Internet, a local area network (LAN), a wireless LAN, a wide area network (WAN), a personal area network (PAN), a Bluetooth network, a near field communication (NFC) network, a satellite broadcasting network, an analog broadcasting network, a digital multimedia broadcasting (DMB) network, and the like.

Only one embodiment for implementing a system for providing user-customized information using an autonomous driving device according to the present invention has been described above, and the present invention is not limited to the embodiment. It will be apparent to those of ordinary skill in the art to which the present invention pertains that various modifications can be made without departing from the spirit of the present invention as stated in the following claims.

1. A system for providing user-customized information using an autonomous driving device, the system comprising:
an autonomous driving device unit configured to recognize at least one user, analyze specific information of the recognized user, recognize and analyze surrounding information of the user, define situation information necessary for the user on the basis of the specific information and the surrounding information, receive customized content information according to the situation information fed back through Internet and intranet searching, and provide the customized content information; and
a server unit connected to the autonomous driving device unit through an Internet and an intranet and configured to extract the customized content information according to a search request from the autonomous driving device unit and feed back the customized content information to the autonomous driving device unit.

2. The system of claim 1, wherein the autonomous driving device unit comprises:
a travel body unit including at least one of an autonomous driving robot and an autonomous driving drone;
an image capturing unit configured to capture an image of the user;
a thermographic sensor unit configured to measure a body temperature of the user using a thermal image;
a user-specific information analysis unit configured to recognize the user on the basis of image data acquired through the image capturing unit and thermographic data acquired through the thermographic sensor unit and analyze the specific information including the recognized user's sex, age group, language group, and abnormality or normality in the body temperature;
a surrounding sensor unit configured to generate the surrounding information by measuring a temperature, a humidity, and an air pollution level of surroundings of the user;
a content feedback request unit configured to extract the situation information which is predefined in connection with the specific information and the surrounding information, request the customized content information from the server unit on the basis of the extracted situation information, and receive the customized content information; and
a display unit configured to graphically process the customized content information fed back from the server unit through the content feedback request unit and display the graphically-processed customized content information.

3. The system of claim 2, wherein the display unit provides the customized content information through a touchscreen which supports a user interface, receives a search request for additional information for the customized content information through the user interface, transmits the search request for the additional information to the server unit, receives feedback information resulting from the search request for the additional information from the server unit, and displays the feedback information.

4. The system of claim 3, wherein the display unit generates and displays graphic code for the customized content information and the additional information, and
when the graphic code is scanned through a user communication terminal, the server unit is connected to the user communication terminal and provides the customized content information and the additional information to the user communication terminal.

5. The system of claim 2, wherein the server unit comprises:
a search means setting unit configured to receive a search request for the situation information from the autonomous driving device unit and set at least one of the Internet and the intranet as a means of searching for the situation information;
an Internet content information providing unit configured to search the Internet for content related to the situation information, collect the content, and provide the collected data as the customized content information when the Internet is set as the search means by the search means setting unit; and
an intranet content information providing unit configured to extract data which is prestored in connection with the situation information from the intranet and provide the data as the customized content information when the intranet is set as the search means by the search means setting unit.
